(19) United States
(12) Patent Application Publication
(10) Pub. No.: US 2007/0031693 A1
(43) Pub. Date: Feb. 8, 2007

(54) Method of processing wood and compressed wood product

(75) Inventors: Tatsuya Suzuki, Tokyo (JP); Yuko Nakajima, Tokyo (JP)

Correspondence Address: HOGAN & HARTSON L.L.P., 1999 AVENUE OF THE STARS, SUITE 1400, LOS ANGELES, CA, 90067, US

(73) Assignee: OLYMPUS CORPORATION

(21) Appl. No.: 11/434,397

(22) Filed: May 15, 2006

(30) Foreign Application Priority Data
Aug. 8, 2005 (JP) 2005-229843
Jan. 18, 2006 (JP) 2006-010228

(51) Int. Cl. B32B 21/04; B27N 3/08

(52) U.S. Cl. 428/537.1; 264/239

(57) ABSTRACT

A method of processing wood in which a wooden piece is compressed into a predetermined three-dimensional shape, includes compressing a portion of the wooden piece at a compression rate of at least 0.75 in a thickness direction of the portion of the wooden piece.

### CROSS-REFERENCE TO RELATED APPLICATIONS

This application is a continuation of PCT international application Ser. No. PCT/JP2006/306374 filed Mar. 22, 2006 which designates the United States, incorporated herein by reference, and which claims the benefit of priority from Japanese Patent Applications No. 2005-229843, filed Aug. 8, 2005; and No. 2006-010228, filed Jan. 18, 2006, incorporated herein by reference.

### BACKGROUND OF THE INVENTION

1. Field of the Invention

The present invention relates to a method of processing wood according to which wood is processed into a three-dimensional shape, and a compressed wood product formed from wood through compression.

2. Description of the Related Art

In recent years, wooden materials that are natural materials attract attention. With a wide variety of grain patterns, wood products made of wood exhibit individual features depending on positions of the raw wood from which the particular wood products are cut out. Such individual features of each wood product give it a unique quality. In addition, surface flaws and discolorations caused by a long-term use create unique textures which tend to evoke warm and familiar feeling in the user. Thus, the wooden material attracts attention as a material for products of uniqueness and taste which cannot be found in products made of synthetic resin or light metals. Techniques for processing wooden materials are also developing dramatically.

According to one conventionally known technique for processing wooden materials: a wooden board is softened with water absorption and compressed; the compressed wooden board is cut along a direction substantially parallel with a direction in which the compressive force is applied, whereby a primary fixed product with a sheet-like shape is obtained; and the primary fixed product is deformed into a desired three-dimensional shape under heat and moisture (for example, see Japanese Patent No. 3078452 Publication). Further, according to another conventional technique, a softened wooden sheet is compressed and temporarily secured in a prepared mold and left in the mold until the wooden sheet recovers. Thus a wooden product with a desired shape can be obtained (see, for example, Japanese Patent Application Laid-Open No. H11-77619 Publication). According to these techniques, the thickness and/or the compression rate of the wooden material is determined based on various factors, such as individual specificity of each wooden material, type of wood, strength required in processed wood, and use of the processed wood.

### SUMMARY OF THE INVENTION

A method of processing wood, according to one aspect of the present invention, in which a wooden piece is compressed into a predetermined three-dimensional shape includes compressing a portion of the wooden piece at a compression rate of at least 0.75 in a thickness direction of the portion of the wooden piece.

A compressed wood product according to another aspect of the present invention has a predetermined three-dimensional shape obtained through a compression process of a wooden piece, and includes a wooden piece that is at least a part of the compressed wood product and that has a translucent portion.

### BRIEF DESCRIPTION OF THE DRAWINGS

FIG. 1 is a perspective view showing an external configuration of a digital camera whose jacket is a compressed wood product according to a first embodiment of the present invention;

FIG. 2 is a perspective view showing a configuration of the compressed wood product (cover member that covers a front side of the digital camera) according to the first embodiment of the present invention;

FIG. 3 is a sectional view taken along line A-A of FIG. 2;

FIG. 4 is a schematic diagram showing an outline of a compression process in a method of processing wood according to the first embodiment of the present invention;

FIG. 5 is a perspective view showing a configuration of a metal mold which is employed to apply compressive force to a wooden piece from above;

FIG. 6 is a sectional view taken along ling B-B of FIG. 4;

FIG. 7 is a vertical sectional view of the wooden piece in a compressed state during the compression process (where deformation of the wooden piece has been nearly finished);

FIG. 8 is a schematic view showing a configuration of a metal mold employed at formation of a compressed wood product according to a second embodiment of the present invention;

FIG. 9 is a sectional view taken along line C-C of FIG. 8;

FIG. 10 is a perspective view showing a configuration of the compressed wood product (cover member) according to the second embodiment of the present invention;

FIG. 11 is a sectional view taken along line D-D of FIG. 10;

FIG. 12 is a schematic view showing a configuration of a compressed wood product (vase) according to a third embodiment of the present invention;

FIG. 13 is a schematic view showing a configuration of a compressed wood product (watering pot) according to one modification of the third embodiment of the present invention;

FIG. 14 is a schematic view showing a configuration of a compressed wood product (caster) according to a fourth embodiment of the present invention;

FIG. 15 is a schematic view showing a configuration of a compressed wood product (table lamp) according to a fifth embodiment of the present invention;

FIG. 16 is a schematic view showing a configuration of a compressed wood product (garden lamp) according to a sixth embodiment of the present invention;

FIG. 17 is a schematic view showing a configuration of a compressed wood product (night light) according to one modification of the sixth embodiment of the present invention;

FIG. 18 is a schematic view showing a configuration of a compressed wood product (aroma pot) according to a second modification of the sixth embodiment of the present invention;

FIG. 19 is a schematic view showing a configuration of a compressed wood product (table) according to a seventh embodiment of the present invention; and

FIG. 20 is a schematic view showing a configuration of a compressed wood product (doorknob) according to an eighth embodiment of the present invention.

### DETAILED DESCRIPTION OF THE PREFERRED EMBODIMENTS

Preferred embodiments (hereinbelow simply referred to as “embodiments”) of the present invention will be described below with reference to the accompanying drawings.

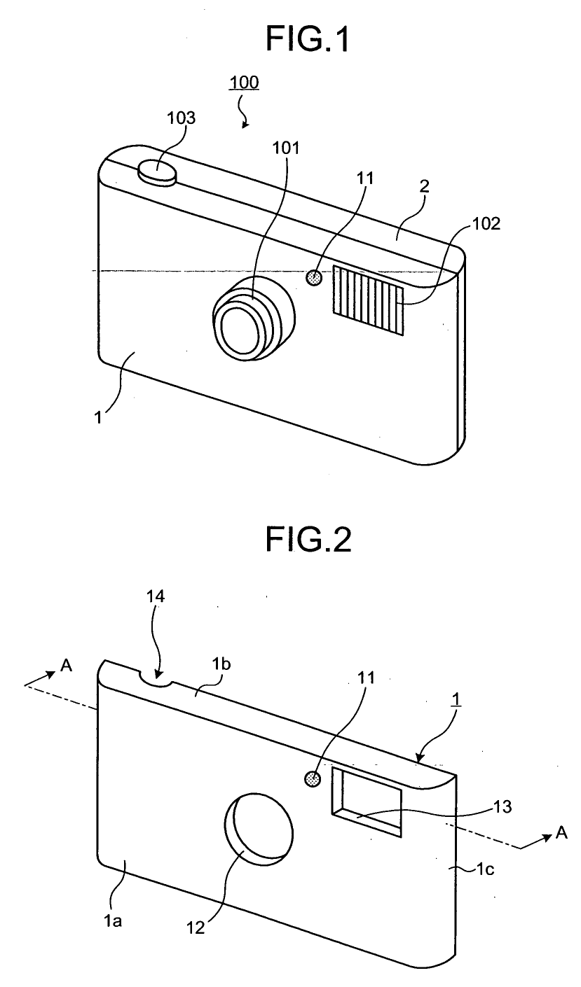

FIG. 1 shows an example of application of a compressed wood product according to a first embodiment of the present invention, and more specifically, is a perspective view of an external configuration of a digital camera which is covered by cover members formed from the compressed wood products according to the first embodiment. A digital camera 100 shown in FIG. 1 includes an image pick-up unit 101 having an imaging lens, a photoflash 102, and a shutter button 103, and two cover members 1 and 2 which both serve as exterior parts. Inside the digital camera 100, various electronic components and optical components (not shown) are housed to realize functions of the digital camera 100. Housed components are, for example, a control circuit that performs drive control related to image pick-up process or the like, a solid-state image sensing device such as a charge coupled device (CCD) or complementary metal-oxide semiconductor (CMOS) camera module, an audio input/output device such as microphone or speaker, and a drive circuit that drives each functional component under control by the control circuit.

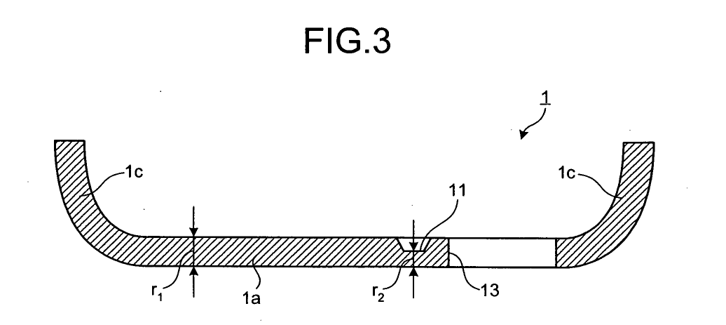

FIG. 2 is a perspective view showing a schematic configuration of the cover member 1 which covers a front side (a side facing an object when taking a picture) of the digital camera 100. FIG. 3 is a sectional view taken along line A-A of FIG. 2. The cover member 1 formed from the compressed wood product shown in FIGS. 1 to 3 includes a substantially rectangular main plate portion 1a, two side plate portions 1b that extend in a lengthwise direction of the main plate portion 1a making a predetermined angle to the main plate portion 1a, and two side plate portions 1c that extend in a breadthwise direction of the main plate portion 1a making a predetermined angle to the main plate portion 1a, and has a substantially bowl-like shape.

The main plate portion 1a has a thin portion 11 which is formed as a truncated conical depression in an internal face (an upper surface in FIG. 3) of the main plate portion 1a and whose thickness is smaller than that of other portion of the main plate portion 1a, a circular opening 12 which exposes the image pick-up unit 101, and a rectangular opening 13 which exposes the photoflash 102. The side plate portion 1b has a semi-circular cut-out portion 14. In the thin portion 11, wood is compressed to such a degree that the thin portion 11 does not exhibit inherent characteristics of wood and thus transmits light dissimilar to other portions of the cover member 1. In the digital camera 100, a light emitting diode (LED, not shown) used for a self-timer is arranged inside the thin portion 11. The LED blinks when the self-timer is on, and the blinking can be seen through the thin portion 11 from outside the digital camera 100.

The cover member 2, which covers a rear side (a side facing a photographer when taking a picture) of the digital camera 100, has substantially the same shape as the cover member 1. The cover member 2, similarly to the cover member 1, has appropriate openings and a cut-out portion to expose necessary components housed in the digital camera 100. For example, the cover member 2 has a semi-circular cut-out portion which has the same shape as the cut-out portion 14 and is formed at a corresponding position to the cut-out portion 14. When the cover members 1 and 2 are joined together for the assembly of the digital camera 100, the cut-out portion of the cover member 2 is joined together with the cut-out portion 14 of the cover member 1, and forms an opening to expose the shutter button 103.

The cover member 1 or 2 may have additional openings and cut-out portions in addition to those described above. For example, the cover member 1 or 2 may have an opening for an attachment of a finder, an opening to expose input keys through which the user gives instruction signals for operation, an opening or a cut-out portion to expose a connection interface (such as DC input terminal or USB connecting terminal) for an external device. Still further, the cover member 1 or 2 may have an audio output hole through which sound from the speaker embedded in the digital camera 100 can be heard.

A method of processing wood according to the first embodiment will be described. First, a wooden piece 41,is cut out from uncompressed raw wood (cutting-out process). The cut-out wooden piece is a raw material for the cover member 1. The volume of the cut-out wooden piece is larger than that of a finished piece by an amount to be decreased during a compression process described later. The raw wood to be employed may be selected, for example, from various types of wood, such as, Japanese cypress, hiba cedar, paulownia, Japanese cedar, pine, cherry, zelkova, ebony wood, bamboo, teak, mahogany, and rosewood depending on the use of the cover member 1.

The cut-out wooden piece may have a straight-grain surface, a flat-grain surface, an intermediate pattern between the straight-grain and the flat-grain, or an end-grain surface, and an optimal grain pattern can be selected according to the use of the compressed wood product. Therefore, the grain pattern of the wooden piece is not particularly shown in the drawings.

After the cutting-out process, the cut-out wooden piece is compressed (compression process). In the compression process, the wooden piece is left in water vapor atmosphere of high temperature and high pressure for a predetermined time period so that the wooden piece absorbs moisture in excess and is softened. Here, the high temperature means 100 to 230° C. and more preferably approximately 180 to 200° C. in temperature, and the high pressure 0.1 to 3 MPa (MegaPascal) and more preferably approximately 0.45 to 2.5 MPa in pressure. Alternatively, the wooden piece 41 may be heated by application of high-frequency electromagnetic wave such as microwave rather than by being left in the water vapor atmosphere as described above.

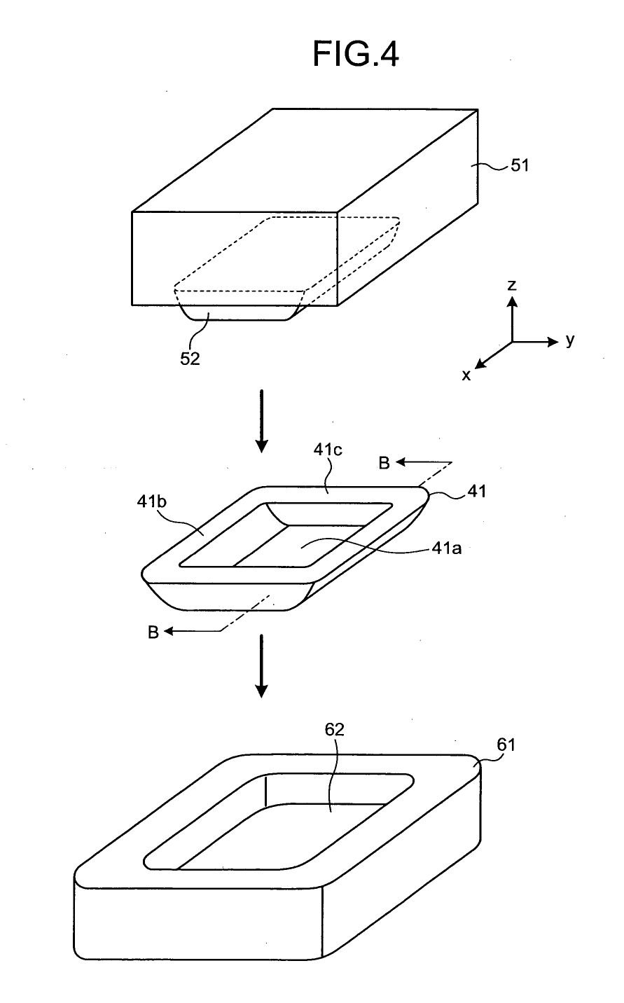

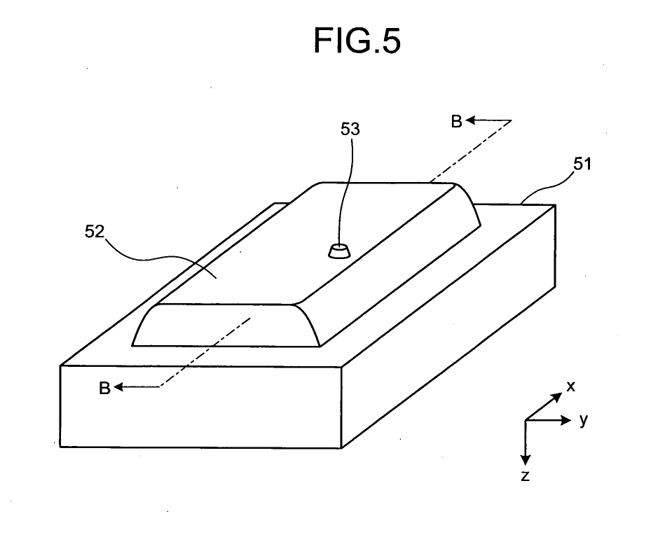

Thereafter, the wooden piece is placed in the same water vapor atmosphere as employed for softening and sandwiched between a pair of metal molds and is subjected to a predetermined amount of compressive force. FIG. 4 schematically shows the compression process. In FIG. 4, a metal mold 51 which is employed for applying a compressive force to the wooden piece 41 from above has a protrusion 52 shaped so as to fit with the internal face of the wooden piece 41. The internal face of the wooden piece 41 extends and curves from the main plate portion 41a to side plate portions 41b and 41c, respectively. A truncated-conical protruding portion 53 rises from the bottom face of the protrusion 52 as shown in the perspective view of FIG. 5. FIG. 5 shows the metal mold 51 shown in FIG. 4 with upside down. Line B-B (which passes the protruding portion 53 in a direction parallel to the x-axis) of FIG. 5 is the same as line B-B of FIG. 4.

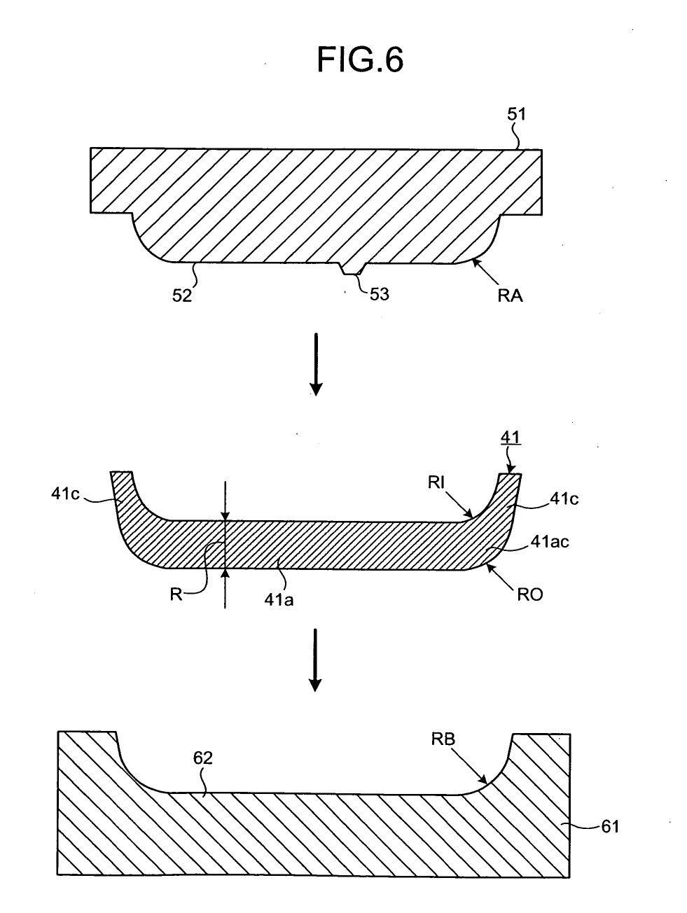

FIG. 6 is a sectional view taken along line B-B of FIG. 4. As shown in FIG. 6, when the radius of curvature of an internal face of a curved portion 41ac extending from the main plate portion 41a to the side plate portion 41c of the wooden piece 41 is represented as RI, and the radius of curvature of a curved surface of the protrusion 52, which abuts the curved portion 41ac, is represented as RA, relation represented by RI>RA holds.

On the other hand, a metal mold 61 which is employed for applying a compressive force to the wooden piece 41 from below in FIG. 4 or 6 has a depression 62 shaped so as to fit with curved external face of the wooden piece 41. The external face extends and curves from the main plate portion 41a to the side plate portions 41b and 41c, respectively. When the radius of curvature of an external face of the curved portion 41ac of the wooden piece 41 is represented as RO, and the radius of curvature of a curved surface of the depression 62, which abuts the external face of the curved portion 41ac, is represented as RB, relation represented by RO>RB holds.

When the metal molds 51 and 61 and the wooden piece 41 placed between the metal molds 51 and 61 are viewed from +x direction towards −x direction along a section perpendicular to the section taken along line B-B of FIG. 4 and passing through the main plate portion 41a, the side plate portion 41b, and the protruding portion 53, it can be seen that the shapes of the metal molds 51 and 61 and their locations relative to the wooden piece 41 are substantially the same as those in FIG. 6 except for the difference in dimension. Here, the radius of curvature of the internal face of the curved portion extending from the main plate portion 41a to the side plate portion 41b is larger than the radius of curvature of the curved face of the metal mold 51, which abuts the internal face, while the radius of curvature of the external face of the curved portion extending from the main plate portion 41a to the side plate portion 41b is larger than the radius of curvature of the curved face of the metal mold 61, which abuts the external face.

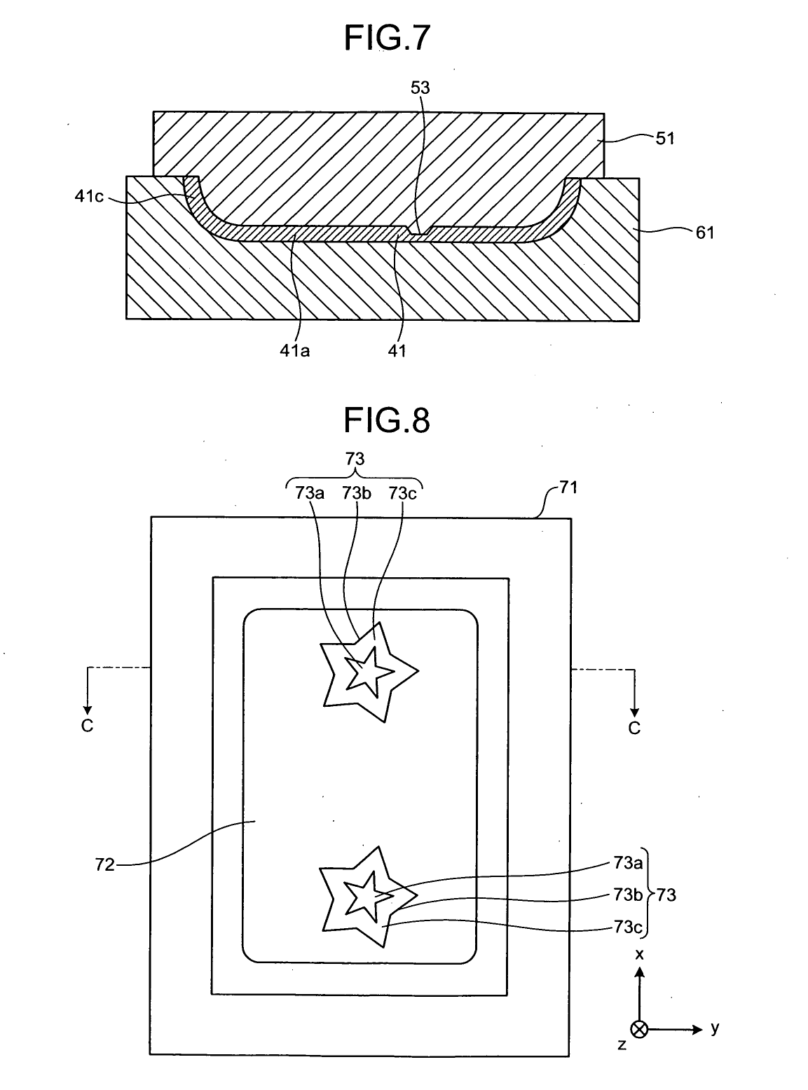

FIG. 7 is a vertical sectional view along the same section as shown in FIG. 6 and shows the wooden piece 41 sandwiched and compressed by the metal molds 51 and 61 (in a state where the deformation of the wooden piece 41 has been nearly finished). As shown in FIG. 7, the wooden piece 41 is deformed through the compression into a three-dimensional shape corresponding to the shape of a space between the metal molds 51 and 61. When the wooden piece 41 is compressed, the compression rate varies in the main plate portion 41a, and is higher in the portion abutting the protruding portion 53 than in other portions. In the first embodiment, the compression rate (i.e., the ratio of the decreased thickness ΔR by the compression to the thickness R before the compression, represented as ΔR/R) in the portion compressed by the protruding portion 53 is at least 0.75, and more preferably at least 0.80. As a result, specific gravity of the compressed portion is approximately 1.4, which is close to the specific gravity 1.5 of a substance of cell walls in general wood. Here, the range of the compression rate is 0≦(ΔR/R)<1.

It is known that when the wooden piece is compressed in the water vapor atmosphere of high temperature and high pressure as described above until the specific gravity thereof becomes approximately 1.5, the characteristics of the wooden piece alters. Under such condition, the wooden piece loses inherent characteristics of wood. For example, the grain patterns disappear and the wooden piece is fluidized (see, for example, Kitazawa, Kitamura, Shibuya, and Kojima, “Phenomenon of Permanent Fixation of Compressed Cedar Obtained by Consolidation nearly to Limit” 21th Annual Convention Proceedings, Wood Technological Association of Japan, 2003). When the wooden piece undergoes such alteration through compression, it substantially turns into resin, which exhibits tortoiseshell-like color tone and transmits light. Therefore, a wood product which has a translucent portion can be fabricated from one piece of wood without the use of a separate, transparent member as in the conventional art.

After the wooden piece 41 is left in the state shown in FIG. 7 for a predetermined time period, the metal molds 51 and 61 are separated from each other to release the wooden piece 41 from compression. Then the water vapor atmosphere is removed and the wooden piece 41 is dried. Thus, an original form of the cover member 1 is finished. As a result of the compression process, the thickness r₁ of the main plate portion 41a becomes substantially uniform over the entire area except the thin portion 11. The compression rate C₁=(R−r₁)/R in the thickness direction of the main plate portion 41a except for the thin portion 11 is approximately 0.40 to 0.70, and more preferably approximately 0.50 to 0.70.

For the clarification, examples of specific values are given. When the thickness R of the main plate portion 41a before the compression is 3.2 mm, and the thickness r₁ of the main plate portion 41a after the compression is 1.6 mm, the compression rate C₁ of the main plate portion 41a except for the thin portion 11 is 0.50. On the other hand, when the thickness r₂ of the thin portion 11 is 0.80 mm, the compression rate C₂=(R−r₂)/R of the thin portion 11 is 0.75. When a further compression can be conducted within a range that would not compromise the strength of the wooden piece, the thickness of the thin portion 11 may be further decreased down to approximately 0.40 to 0.50 mm, to further enhance the transparency of the thin portion 11. Alternatively, for the enhancement of the transparency, the portion to be processed into the thin portion 11 may be initially formed so that the portion is thinner than other portions of the main plate portion, and the compression process may be controlled so that the compression rate in the thin portion is at least 0.75, and more preferably at least 0.80.

In the compression process described above, an appropriate driving unit may be provided to electrically drive at least one of the metal molds 51 and 61 to realize vertical relative movement of the metal molds 51 and 61. Alternatively, the metal molds 51 and 61 may be screwed with each other, so that the vertical relative movement of the metal molds 51 and 61 can be realized by manual or automatic screwing.

The compressed wood product according to the first embodiment is applicable as a jacket for electronic equipments other than a digital camera, for example, electronic equipments such as a portable communication terminal such as a portable telephone, personal handyphone system (PHS), and a personal digital assistant (PDA), a portable audio device, an IC recorder, a portable television, a portable radio, remote controls of various home appliances, and a digital video. When the compressed wood product is applied as a jacket for a small portable electronic equipment as listed above, the thickness after the compression may be preferably set to approximately 1.6 mm. When a light-emitting device is arranged in the electronic equipment so that the light-emitting device is located right inside the thin portion, the light emitted from such a device can be transmitted to the outside without the use of separate, transparent member.

According to the first embodiment as described above, a translucent property can be given to a portion of the wooden piece, i.e., the thin portion, since the compression process, which is performed to deform the wooden piece into a predetermined three-dimensional shape, is controlled so that the compression rate in the thin portion is at least 0.75 in the thickness direction. Therefore, even when the wood product is required to have a translucent portion, such wood product can be manufactured from a fewer parts through a fewer process steps. Thus, a more economical method of processing wood and a compressed wood product can be provided.

Further, according to the first embodiment, since the translucent portion is integrally formed with other portions from the same material, sealing quality of the compressed wood product can be enhanced compared with the product formed from separate members. When such compressed wood product is applied as a jacket for the electronic equipment, moisture can be prevented from intruding into the electronic equipment by capillary action between separate members.

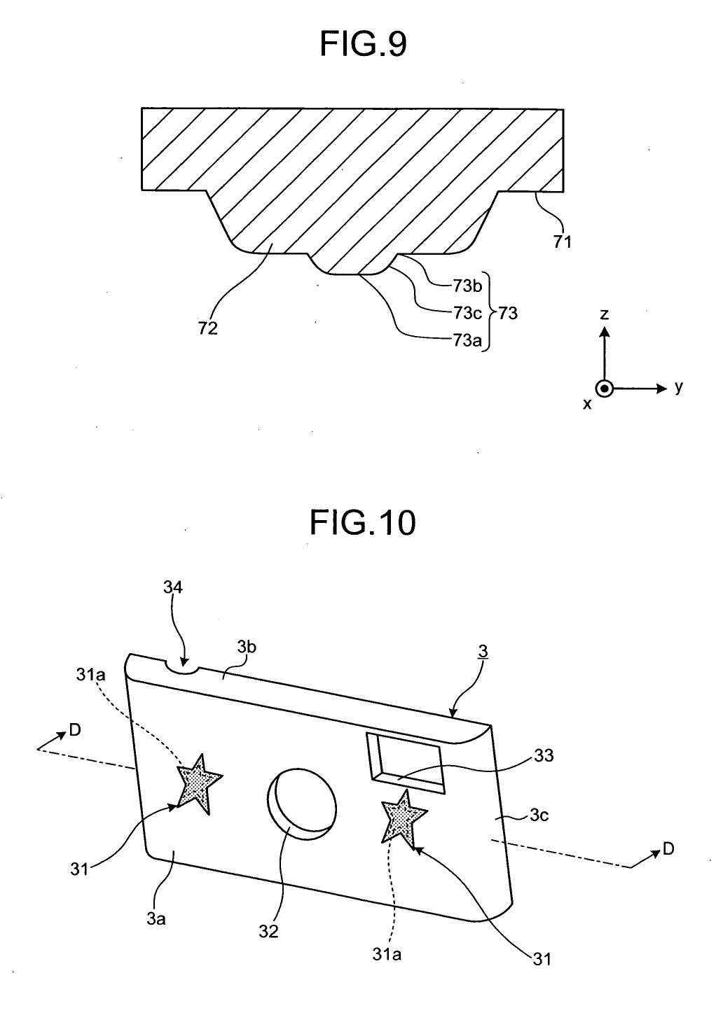

FIG. 8 is a bottom view showing the configuration of the metal mold employed in a method of processing wood according to a second embodiment of the present invention. FIG. 9 is a vertical sectional view of the metal mold taken along line C-C of FIG. 8. In FIG. 9, the metal mold is arranged so that the +z direction in the coordinate of FIG. 8 corresponds to the vertically upward direction in FIG. 9. In the second embodiment, a wooden piece taken out from unprocessed raw wood is the wooden piece 41 as in the first embodiment. The compressed wood product to be manufactured through compression has substantially the same shape as the cover member 1, and is employed as a jacket for the digital camera.

A metal mold 71 shown in FIGS. 8 and 9 has a protrusion 72 shaped so as to fit with the internal face of the wooden piece 41 extending and curving from the main plate portion 41a to the side plate portions 41b and 41c. From the bottom portion of the protrusion 72, two protruding portions 73 project downward. The protruding portion 73 has a star-shaped bottom portion 73a, an outer rim 73b that has a similar star shape to the shape of the bottom portion 73a, has a size larger than the bottom portion 73a, and forms a boundary between the protruding portion 73 and the bottom face of the protrusion 72, and a slope 73c extending between the bottom portion 73a and the outer rim 73b and forming a gentle curve.

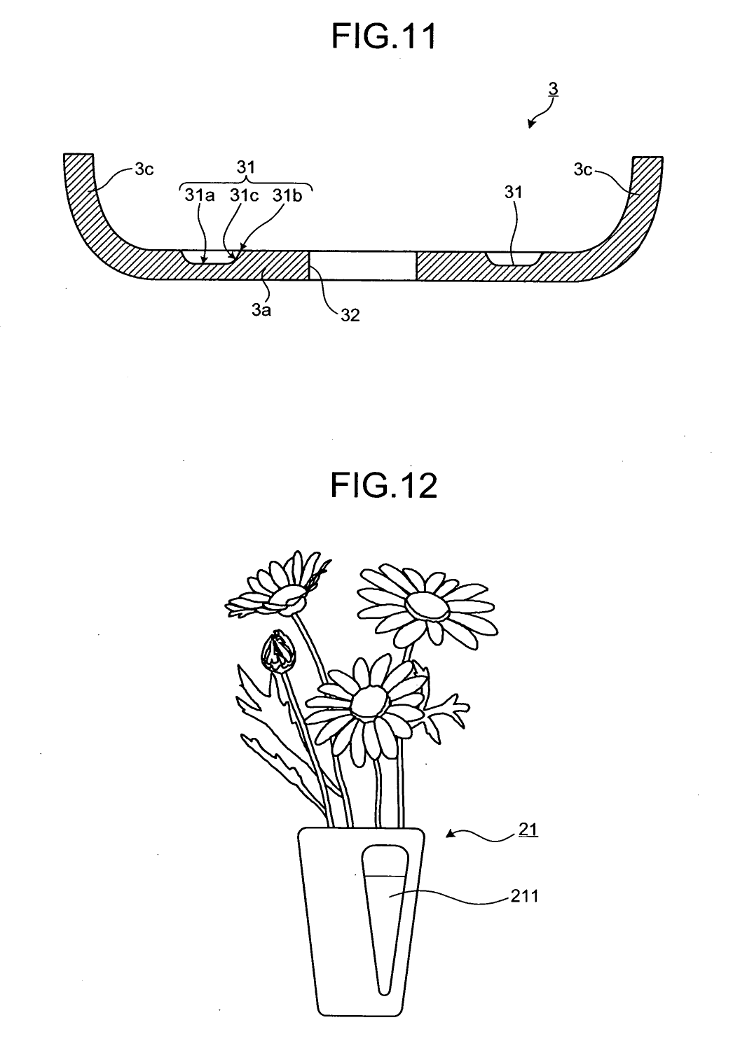

FIG. 10 is a perspective view of a configuration of a cover member which is formed from a compressed wood product formed through the compression by the metal molds 71 and 61. FIG. 11 is a sectional view taken along line D-D of FIG. 10. A cover member 3 shown in FIGS. 10 and 11, similarly to the cover member 1, includes a substantially rectangular main plate portion 3a, two side plate portions 3b that extend in a lengthwise direction of the main plate portion 3a making a predetermined angle to the main plate portion 3a, and two side plate portions 3c that extend in a breadthwise direction of the main plate portion 3a making a predetermined angle to the main plate portion 3a, and has a substantially bowl-like shape.

The main plate portion 3a has two thin portions 31 each of which is thinner than other portions and has a star-shaped surface, a circular opening 32 that is arranged between the two thin portions 31 and exposes the image pick-up unit 101, and a rectangular opening 33 that exposes the photoflash 102. Further, the side plate portion 3b has a semi-circular cut-out portion 34.

A portion of the wooden piece abuts the protruding portion 73 of the metal mold 71 and is compressed between the protruding portion 73 of the metal mold 71 and the depression 62 of the metal mold 61, and turns into the thin portion 31 which transmits light similarly to the thin portion 11 of the first embodiment. In the second embodiment, since the slope 73c of the protruding portion 73 formed in the metal mold 71 forms a gently curved surface, a slope 31c extending from the bottom portion 31a, which is the thinnest in the thin portion 31, to the outer rim 31b gradually becomes thicker. Hence, the compression rate of the thin portion 31 in the main plate portion 3a, is the highest in the bottom portion 31a and gradually decreases towards the outer rim 31b. Specifically, the compression rate of the bottom portion 31a is at least 0.75 and more preferably at least 0.80, while the compression rate of the outer rim 31b is, similarly to the compression rate of other portion in the main plate portion 41a, approximately 0.40 to 0.70, and more preferably approximately 0.50 to 0.70.

When light is incident on the thin portion 31 with the above-described configuration, the transmitted light changes its tone gradually from the bottom portion 31a to the outer rim 31b. For example, light transmittance is the highest in the bottom portion 31a, which is the thinnest, and gradually decreases towards the outer rim 31b; in other words, the transmitted light gradually becomes weaker from the bottom portion 31a towards the outer rim 31b. The combination of the variation in light transmittance and the variation in tortoiseshell-like color tone generated by compression and varied according to the thickness gives a subtle gradation to the star-like pattern of the thin portion 31. Through the control of the temperature and pressure of the water vapor atmosphere employed at the compression, various types of gradation can be realized, which further grants individual features to each compressed wood product.

A feature of the second embodiment lies in that wood processing is performed so that a portion which is transformed into the resin-like state through compression and a portion which remains woody even through compression are present in the same product side by side, and a product with more sophisticated design is provided. Therefore, in the second embodiment, the resin-like portion does not require as large a transparency as the thin portion of the first embodiment. Hence, the bottom portion 31a of the cover member 3 is not necessarily as thin as the thin portion 11 of the cover member 1.

According to the second embodiment as described above, even when the wood product is required to have a translucent portion, such wood product can be manufactured from a fewer parts through a fewer process steps, similarly to the first embodiment. Thus, a more economical method of processing wood and a compressed wood product can be provided.

Further, according to the second embodiment, since the protruding portion of the metal mold has a gently curved slope, the thin portion of the compressed wood product may have a tone gradation, which contributes to improve the design of the compressed wood product. Hence, the method of processing wood according to the second embodiment is also suitable for the processing of the compressed wood product other than jackets of the electronic equipments. For example, the method of the second embodiment can be applied to the processing of casings such as a case for glasses and a powder compact, and accessories.

Needless to say, the shape and the number of the protruding portions formed on the metal mold are determined according to various conditions, such as the shape or use of the finished compressed wood product, and the type of wood to be employed.

FIG. 12 shows a configuration of a vase which is a compressed wood product according to a third embodiment. A vase 21 of FIG. 12 is formed from compressed wood, and has a translucent thin portion 211 which is formed along a vertical direction in FIG. 12. The thin portion 211 is formed from compressed wood in which the compression rate in the thickness direction is at least 0.75 and more preferably at least 0.80.

In the third embodiment, since the vase 21 has the thin portion 211 as described above, the amount of water in the vase 21 can be visually confirmed from outside. Further, in the third embodiment, since the thin portion 211 is formed integrally with other portions of the vase 21, there is no junction where a separate, transparent member is adhered to other portion, whereby the sealing property of the vase can be improved and the water inside the vase 21 can be prevented from leaking to the outside.

In FIG. 12, the thin portion 211 is formed in an inverted-triangular shape whose width gradually decreases downward, similarly to the side view of the vase 21 itself. Such a shape of the thin portion 211 is mere example. The thin portion may have any shape as long as the thin portion allows the visual confirmation of the amount of water in the vase.

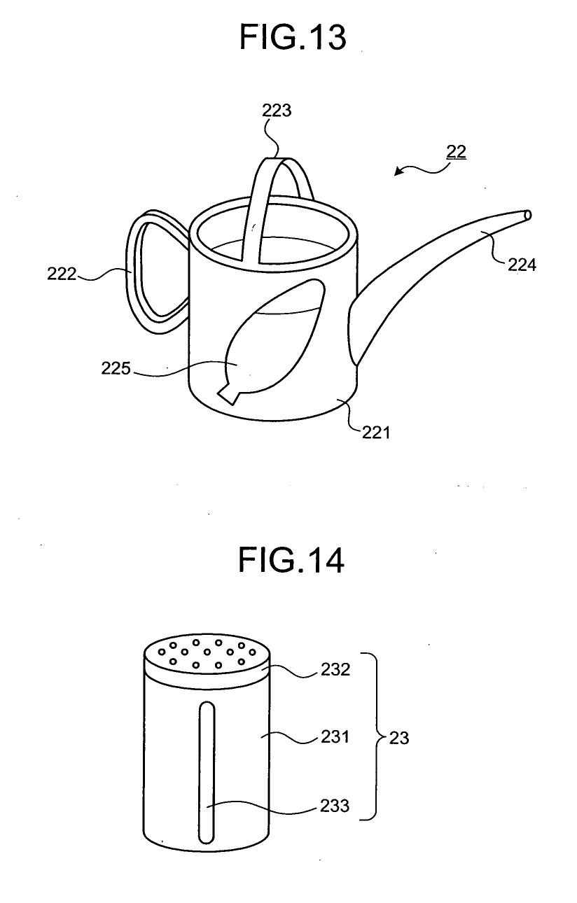

FIG. 13 shows a configuration of a watering pot which is a compressed wood product according to a modification of the third embodiment. A watering pot 22 shown in FIG. 13 has a main body 221 formed from compressed wood, a handle 222, a grip 223, and a spout 224. The main body 221 has a translucent thin portion 225 which is of a substantially leaf shape. The thin portion 225 allows for the visual confirmation of the amount of water inside the main body 221 therethrough similarly to the thin portion 211 of the vase 21. The handle 222, the grip 223, and the spout 224 may be formed from material other than wood (such as metal or synthetic resin).

A compressed wood product according to another modification of the third embodiment may be a covering member (not shown) for a main body of a pot. Such covering member may have a thin portion at a position corresponding to a water meter provided on the pot to indicate the amount of water contained in the pot, so that the water meter can be seen from outside when the covering member is attached to the pot. In this case, the entire main body of the pot may be formed from a transparent material, or only the water meter may be formed from a transparent material. In either case, the amount of water inside the pot can be visually confirmed from the outside via the thin portion.

The compressed wood product according to the third embodiment can be formed through compression similarly to the compressed wood products of the first and the second embodiments with the use of metal molds that are shaped corresponding to the finished shape of the compressed wood product in the water vapor atmosphere of high temperature and high pressure. The same applies to a fourth embodiment to an eighth embodiment described below.

FIG. 14 shows a configuration of a caster which is a compressed wood product according to the fourth embodiment. A caster 23 shown in FIG. 14 serves to store powder seasonings, such as salt and pepper, and includes a main body 231 formed from a casing-like compressed wooden piece having one open end, and a cap 232 having plural holes and attached to the open end of the main body 231. The cap 232 is formed from metal or synthetic resin.

On a side surface of the main body 231, a translucent thin portion 233 is formed along a vertical direction of FIG. 14. The thin portion 233 is formed from a compressed wooden piece in which the compression rate in the thickness direction is at least 0.75 and more preferably at least 0.80. A remaining amount of seasonings inside the main body 231 can be visually confirmed from outside via the thin portion 233.

Here, instead of the cap 232, a cap having a spout for liquid may be attached to the main body 231. Then, a caster for liquid seasoning such as soy sauce or vinegar can be configured.

When the thin portion 233 is horizontally formed along substantially the entire periphery of the main body 231 instead of along the vertical direction, the caster may serve as a toothpick holder. In this case, the holes in the cap 232 may be formed slightly larger than the diameter of the toothpick.

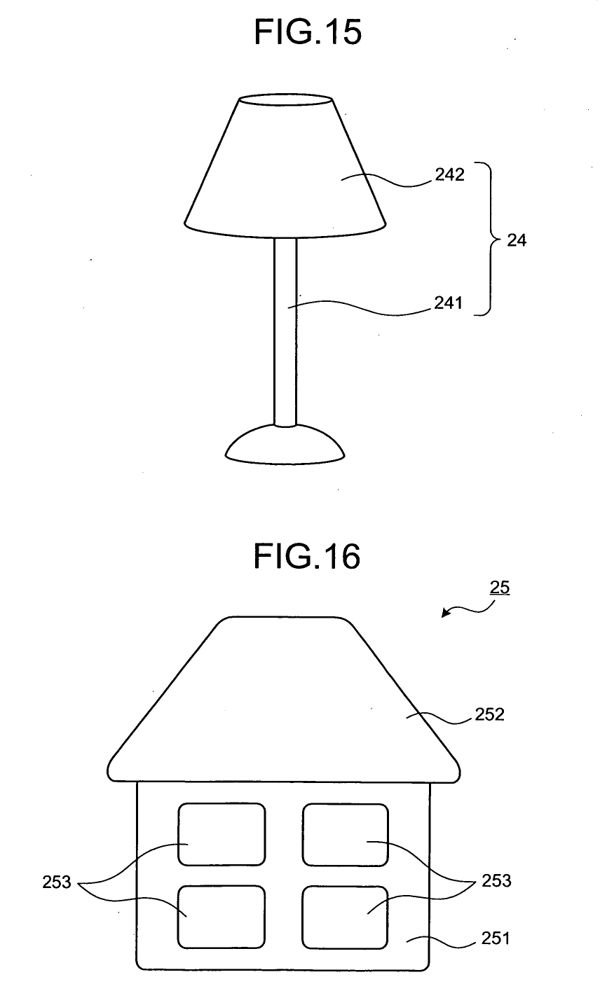

FIG. 15 shows a configuration of a table lamp which is a compressed wood product according to the fifth embodiment. A table lamp 24 of FIG. 15 includes a support base 241 having an electric bulb holder (not shown) which holds an electric bulb on an upper end, and an umbrella-like lamp shade 242 formed from compressed wood and attached to the support base 241 from above the support base 241. The support base 241 may be formed by processing wood, or alternatively formed from other materials such as metal or synthetic resin. In FIG. 15, the electric bulb and a power code that supplies power to the electric bulb are not shown.

The lamp shade 242 is formed by conducting the compression of a wooden piece of substantially uniform thickness taken from the raw wood so that the compression rate in the thickness direction is at least 0.75 and more preferably at least 0.80. The lamp shade 242 transmits light emitted from the electric bulb attached to the support base 241. For example, when a metal mold is configured so that the compression rate in the thickness direction of the wooden piece of the lamp shade 242 gradually increases downward in FIG. 15, the intensity of transmitting light gradually increases downward. When the wooden piece is subjected to the compression and the compression rate is varied according to portions of the lamp shade 242, illumination of the electric bulb may appear to have gradation. The metal mold may be configured so that the compression rate gradually decreases downward in FIG. 15.

In the above description, the wooden piece with a uniform thickness is taken out from the raw wood as a material for the lamp shade 242. Alternatively, at the formation of the lamp shade 242, the wooden piece may be cut out from the raw wood in such a manner that the thickness of the wooden piece gradually changes. Then, the thickness of the wooden piece may be made substantially uniform through the compression. Here, depending on the types of the wood employed for the lamp shade 242, setting of the compression rate of the whole portion to at least 0.75 may compromise the strength of the finished product. Hence, the compression rate may be set lower than 0.75 in some portions so that the strength of the finished lamp shade 242 can be properly maintained.

FIG. 16 shows a configuration of a garden lamp which is a compressed wood product according to the sixth embodiment. A garden lamp 25 of FIG. 16 has an appearance like a house, and includes a main body 251 formed from casing-like compressed wood and capable of housing an electric bulb inside, a roof portion 252 attached on the main body 251, and window-like thin portions 253 provided at a side surface of the main body 251. In FIG. 16, the electric bulb and a power code that supplies power to the electric bulb are not shown.

The thin portion 253 is formed by compressing a wooden piece so that the compression rate in the thickness direction is at least 0.75 and more preferably at least 0.80, and transmits light. Hence, the light emitted from the electric bulb arranged inside the main body 251 passes through the thin portion 253 and illuminates the surroundings. The roof portion 252 may be formed from wood or from other materials such as metal and synthetic resin.

According to the sixth embodiment, the compressed wood product can serve as lighting which illuminates the plants in the garden at night by an appropriate amount of light. Further, since the thin portion 253 is formed integrally with the main body 251, moisture does not come inside the main body 251 at the watering of the plants.

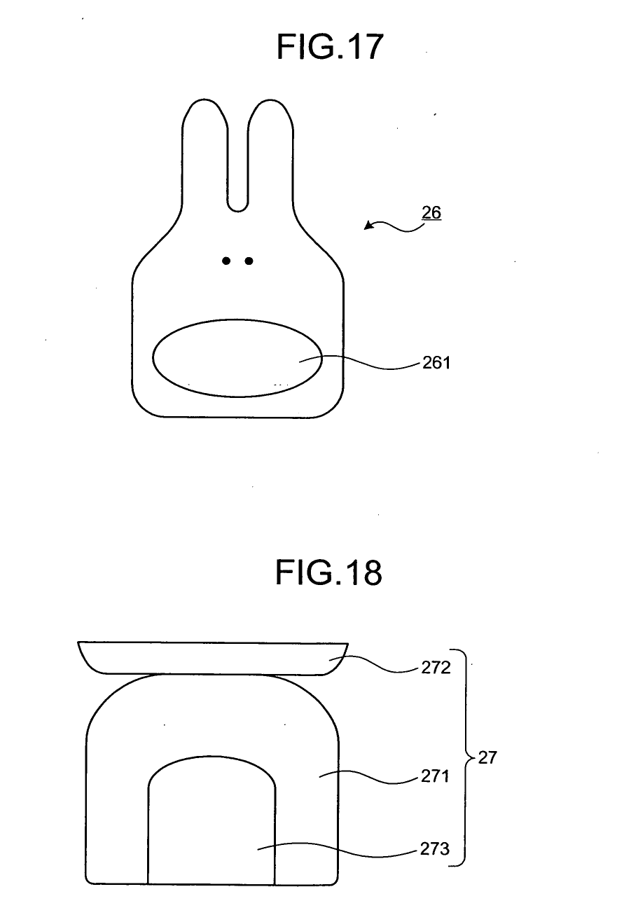

FIG. 17 shows a configuration of a night light which is a compressed wood product according to a first modification of the sixth embodiment. A night light 26 shown in FIG. 17 is formed from compressed wood, and transmits light emitted from an electric bulb arranged inside the night light 26 via a thin portion 261 formed similarly to the thin portion 253 described above. The power to the night light 26 may be supplied through a power receptacle, or from a battery or a battery cell (either not shown).

FIG. 18 shows a configuration of an aroma pot which is a compressed wood product according to a second modification of the sixth embodiment. An aroma pot 27 shown in FIG. 18 has a main body 271 formed from compressed wood and a saucer 272 made of ceramic or the like. The main body 271 is hollow and a candle is arranged inside the main body 271. When the candle is lit, essential oil put into the saucer 272 is warmed. At the same time, the light of the candle is transmitted through the thin portion 273 to the outside. Thus, synergy effect of the flagrance of the warmed essential oil and the transmitted light through the thin portion 273 creates enhanced relaxation effect.

FIG. 19 shows a configuration of a table which is a compressed wood product according to the seventh embodiment. A table 28 shown in FIG. 19 includes a tabletop 281 formed from compressed wood, a base 282 on which the tabletop 281 is placed, and legs 283 that support the base 282. A thin portion 284 is formed at a portion of the tabletop 281 (in the present embodiment, the thin portion 284 is formed at the center of the tabletop 281). The thin portion 284 is formed from compressed wood in which the compression rate in the thickness direction is at least 0.75 and more preferably at least 0.80, and transmits light. Therefore, when the table 28 is configured so that an electric bulb or the like can be arranged near the center of the base 282, in other words, at a position that comes below the thin portion 284 of the tabletop 281 attached to the base 282, the arranged electric bulb can serve as the lighting for the table 28.

In the table 28 with the above-described configuration, since the thin portion 284 is formed integrally with the tabletop 281, even when water or the like is spilled over the tabletop 281, the water or the like does not come through the thin portion 284 and reach a portion below the thin portion 284. Therefore, water or the like can be properly removed only by wiping off the tabletop 281. Thus, the table 28 can be easily maintained in condition and is hygienic.

At the cutting-out of the tabletop, the thickness may be made uneven, and the compression may be performed so that the compression rate at a thickest portion before the compression is at least 0.75 and more preferably at least 0.80. Then, the tabletop obtained by the compression exhibits a marble-like pattern formed by combination of translucent portions and opaque portions. Thus, the electric bulb or the like arranged in the base 282 can give gradation of illumination seen on the tabletop.

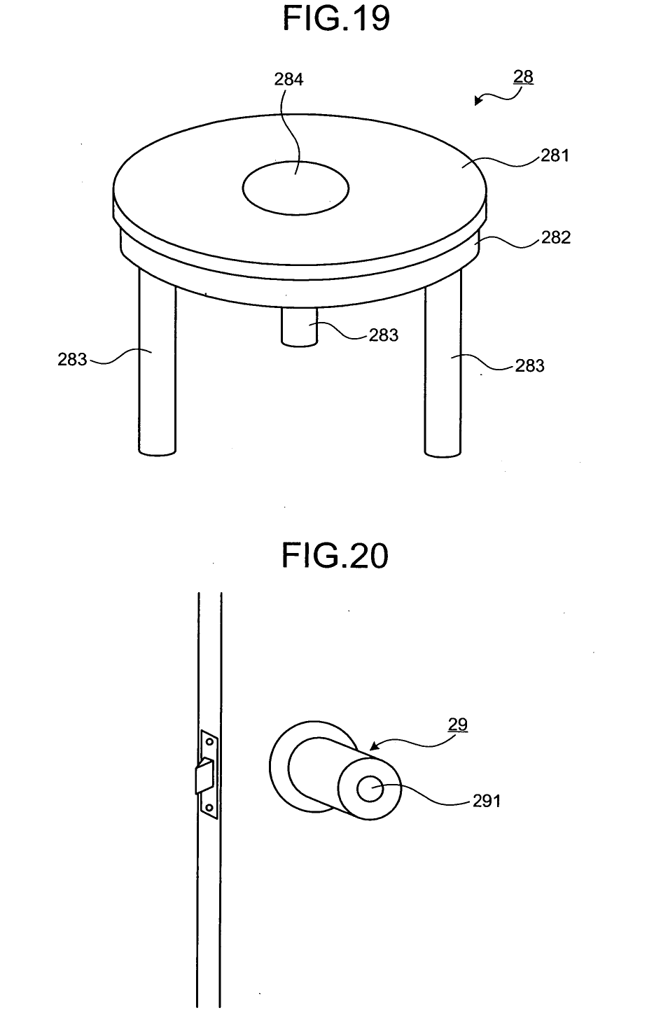

FIG. 20 shows a configuration of a doorknob which is a compressed wood product according to the eighth embodiment of the present invention. A doorknob 29 shown in FIG. 20 is formed from a hollow cylindrical compressed wooden piece having one open end, and a thin portion 291 is formed at a circular bottom face of a close end. The thin portion 291 is formed from compressed wood in which the compression rate in the thickness direction is at least 0.75, and more preferably at least 0.80, and transmits light. A lighting device such as an LED is arranged inside the doorknob 29 so that light emitted from the lighting device is directed towards the thin portion 291. Thus, when the lighting device is lit, the location of the doorknob 29 can be clearly indicated even in the dark at night.

The exemplary embodiments of the present invention are described in detail above as the first to the eighth embodiments. It should be noted, however, that the present invention is not limited to the eight embodiments described above. In other words, the present invention can include various embodiments not described particularly herein, and various modifications in design or the like can be made without departing from the scope of the technical concept defined in the appended claims.

What is claimed is:

1. A method of processing wood in which a wooden piece is compressed into a predetermined three-dimensional shape, comprising
compressing a portion of the wooden piece at a compression rate of at least 0.75 in a thickness direction of the portion of the wooden piece.

2. The method of processing wood according to claim 1, comprising compressing the portion of the wooden piece at a compression rate of at least 0.80 in a thickness direction of the portion of the wooden piece.

3. The method of processing wood according to claim 1, wherein
the wooden piece is sandwiched and compressed by a pair of metal molds.

4. The method of processing wood according to claim 3, wherein
at least one metal mold of the pair of metal molds has a protruding portion which protrudes farther than other portions and which is formed in an area that abuts the wooden piece during compression of the wooden piece.

5. The method of processing wood according to claim 4, wherein
the protruding portion has a slope formed as a curved surface.

6. A compressed wood product with a predetermined three-dimensional shape obtained through a compression process of a wooden piece, comprising
a wooden piece that is at least a part of the compressed wood product and that has a translucent portion.

7. The compressed wood product according to claim 6, wherein
the translucent portion is formed through compression so that a compression rate of the translucent portion in a thickness direction thereof is at least 0.75.

8. The compressed wood product according to claim 7, wherein
the translucent portion is formed through compression so that the compression rate of the translucent portion in the thickness direction thereof is at least 0.80.
